(19) United States
(12) Patent Application Publication
(10) Pub. No.: US 2007/0234969 A1
(43) Pub. Date: Oct. 11, 2007

(54) Tug, toss and bait training device

(76) Inventor: Candace L. Lynch, Estero, FL (US)

Correspondence Address: JAMES RAY & ASSOCIATES, 2640 PITCAIRN ROAD, MONROEVILLE, PA, 15146, US

(21) Appl. No.: 11/402,099

(22) Filed: Apr. 11, 2006

(51) Int. Cl. A01K 29/00

(52) U.S. Cl. 119/707

(57) ABSTRACT

An all-in-one, tug, toss, and bait training device is provided for training and/or playing with an animal, such as a dog. The device comprises a strap member having a first end portion, a second end portion, and middle portion positioned between the first end portion and the second end portion. A throwing member, such as a ball, is secured to the first end portion of the strap member. A handle is one of attached to and formed from the second end portion of the strap member. A holding member, such as a pouch for storing treats, squeaking devices and the like, is secured to the middle portion of the strap member. This training device may be adapted for use for teaching a variety of skills to several different breeds and sizes of dogs.

### FIELD OF THE INVENTION

The present invention relates, in general, to a training device for dogs, and more particularly, to an all-in-one tug, toss, and bait training device for training a variety of skills to different breeds and sizes of dogs.

### BACKGROUND OF THE INVENTION

There are many different devices available for training and/or playing with one's dog. Different breeds and different sizes of dogs and various dog competitions require different devices and/or tools for training different skills. These skills include agility, utility obedience, steeplechase, retrieving, hunting, and the like. For example, playing catch with a ball teaches certain breeds of dogs, such as retrievers, how to retrieve and return an item unharmed. This game consists of a person throwing a ball, the dog retrieving the ball, and then bringing it back to the owner so that he/she may throw it again. A disadvantage of this type of activity is that the ball may become soaked in saliva, making it unpleasant for the owner to continually touch and throw it. U.S. Pat. No. 5,961,406 to Hass attempts to overcome this disadvantage by providing a ball toy having a handle attached for grasping and throwing. This alleviates the unpleasant task of touching a saliva soaked ball.

Another training technique for dogs is to play a tug-of-war game. This is played by having a dog tug on the end of a rope or other item wherein they can grasp one end within their mouth while a person tugs on the other end. This game is especially useful for teaching dogs how to learn how to play and bond with their owners/trainers, as well as, to “charge” them up before a performance competition.

Dogs also enjoy playing with soft items, especially if these items include a squeak toy therein which emits a noise when pressed. U.S. Pat. No. 5,560,320 to Plunk teaches a dog toy having a rope with a knot at one end, which the dog can chew on for hygienic purposes, and a soft squeezable fleece play portion carried by the rope. A squeak toy can be enclosed within the play portion. The Plunk device does not allow one to place other items, which can be used as a tool for training the dog, within the fleece play portion. These items can include treats, which cause the dog to rely on their sense of smell to locate the device or a feather that can teach a retriever how to retrieve the device and return it unharmed.

Depending upon the breed of dog and/or the particular set of tricks one wishes to train their dog, an owner may be forced to purchase a plurality of devices. This can become quite costly and cause a fair amount of clutter from these devices being strewn about the yard and/or house. There is a need in the art for an all-in-one device that enables one to train his/her dog without forcing the owner to purchase a plurality of different devices. There is also a need in the art for an all-in-one training tool that can be used to train a variety of skills to a variety of breeds and sizes of dogs. There is a further need in the art for a training device that allows one to place various items therein to teach a dog to rely on their sense of smell or to teach the dog retrieval skills.

### OBJECTS OF THE INVENTION

It is therefore an object of the invention to provide an inexpensive training device that may be used to train a variety of behaviors to a dog.

It is another object of the invention to provide a training device that may be adapted for use with a variety of breeds of dogs.

It is still yet another object of the invention to provide an all-in-one training device that will reduce one's need for a plurality of training tools.

It is another object of the invention to provide a training device that may be modified as needed to teach a particular skill.

It is still yet another object of the invention to provide a toy for use for those that wish to begin the bonding process with their dogs.

It is yet another object of the invention to provide a training device which is highly durable and economical to manufacture.

In addition to the above-described objects and advantages of the tug, toss, and bait training device, various other objects and advantages of the present invention will become more readily apparent to the persons who are skilled in the same and related arts from the following more detailed description of the invention, particularly, when such description is taken in conjunction with the attached drawing figures and the appended claims.

### SUMMARY OF THE INVENTION

Briefly, and in accordance with the foregoing objects, the invention comprises an all-in-one, tug, toss, and bait training device for training and/or playing with an animal, such as a dog. The device comprises a strap member having a first end portion, a second end portion, and middle portion positioned between the first end portion and the second end portion. A throwing member, such as a ball, is secured to the first end portion of the strap member. A handle is one of attached to and formed from the second end portion of the strap member. A holding means, such as a pouch for storing treats, squeaking devices and the like, is secured to the middle portion of the strap member. This training device may be adapted for use for teaching a variety of skills to several different breeds and sizes of dogs.

### BRIEF DESCRIPTION OF THE DRAWINGS

FIG. 1 shows a perspective view of a small tug, toss, and bait training device of the present invention.

FIG. 2 shows a partial perspective view of a large tug, toss, and bait training device of the present invention.

FIG. 3 shows a partial view of an optional handle portion of the tug, toss, and bait training device of the present invention.

### DETAILED DESCRIPTION OF THE INVENTION

Before describing the invention in detail, the reader is advised that, for the sake of clarity and understanding, identical components having identical functions have been marked where possible with the same reference numerals in each of the Figures provided in this document.

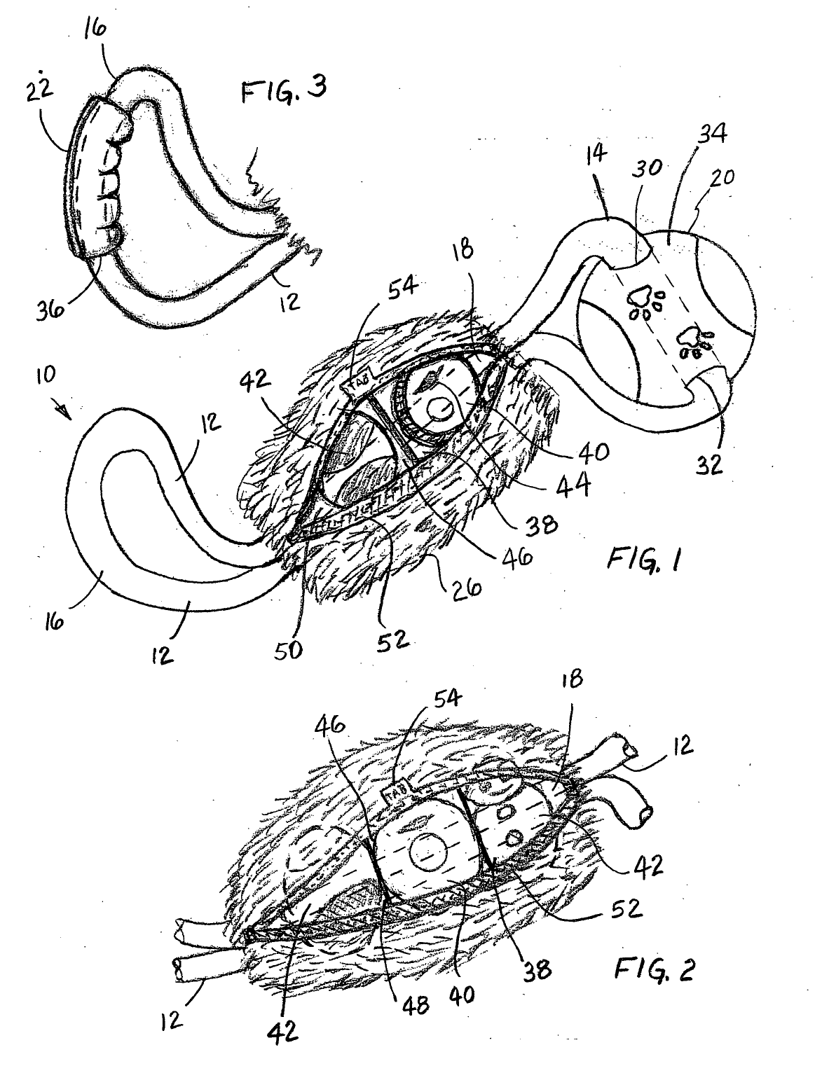

Referring now to FIGS. 1-2, there is shown the tug, toss, and bait training/playing device, generally illustrated as 10, of the invention. The training/playing device 10 of the invention comprises a strap member 12 having a first end portion 14, a second end portion 16, and middle portion 18 positioned between the first end portion 14 and the second end portion 16. A throwing member 20, such as a ball, is secured to the first end portion 14 of the strap member 12. A handle is either attached to, 22 as shown in FIG. 3, or formed from 24, as shown in FIG. 1, the second end portion 16 of the strap member 12. A holding means 26, such as a pouch, having a predetermined size and shape, is secured to the middle portion 18 of the strap member 12.

The ball 20 can include a hollow center 28 and at least two openings 30, 32 extending through a wall portion 34 thereof. The first end portion 14 of the strap member 12 is threaded through these at least two openings 30, 32 to secure the ball 20 to the strap member 12.

The strap member 12 is formed from a strong material such as a reinforced nylon or a canvas material or any other type of material that is sufficiently strong to withstand the pulling force applied thereto from the dog during the tug game.

Preferably, as shown in FIG. 1, the strap member 12 is a single continuous loop and the handle 24 is formed from the second end portion 16 of the strap member 12. Alternatively, if one would like to alleviate some of the pressure applied to one's hand while playing the tug game with the dog, an optional handle 22, as shown in FIG. 2, may be attached to the second end portion 16 of the strap member 12. This may be a desirable addition should one be training/playing with a large breed of dog. This optional handle 22 may be formed from any well-known material such as wood, rubber, and plastic, and the like. It may be attached to the second end portion 16 of the handle by providing an opening 36 in the handle 22 such that the strap member 12 may extend through this opening and to thread the handle 22 thereon.

The holding means or pouch 26 has at least one pocket 38 therein for holding at least one item for one of training and playing with the dog. The at least one item can comprise at least one treat 40, one or more squeaking devices 42, at least one feather 44, and any other type of training tool that an owner believes would assist in teaching a particular skill to the dog. The pouch 26 can include two or more pockets 38 for holding two or more different items. For example, as shown in FIG. 1, a small training device 10 has a small pouch 26, which includes one pocket 38 for holding a treat 40 and a second pocket 46 for holding a squeaking device 42. As shown in FIG. 2, a large training device 10, has a larger pouch 26, which may include three or more pockets such as one pocket 38 for holding a treat 40, a second pocket for holding a squeaking device 42, and a third pocket 48 for holding another squeaking device 42.

The pouch 26 further includes at least one opening 50 for placing and removing these items 40, 42, 44 from within the pocket(s) 38, 46, 48 of the pouch 26. The at least one opening 50 includes means for closing 52 the at least one opening 50. This closing means can be any well-known device such as a hook and loop fastener (Velcro®), a zipper, at least one snap, at least one button and the like. A tab 54 may be provided to assist the use with opening the pouch 26 for retrieving the item(s) for within the pocket(s).

The holding means/pouch 26 is formed from a soft material. Preferably, this soft material is animal fur, such as rabbit fur. However, any other well known soft material can be used, such as an imitation animal fur or faux fur, a heavy duty fleece or any other heavy duty soft material. The material must have sufficient strength and durability to withstand pulling, tugging, and chewing by the dog.

Additional reinforcement may be provided to the holding means/pouch 26 by sewing the middle portion 18 of the strap member 12 throughout either the interior or exterior portion of the pouch 26.

One having ordinary skill in the art would recognize that various modifications in terms of size, color, shape, and the like may be made to the tug, toss and bait training device of the present invention. This all-in-one device is unique in that it may be customized as needed and can be adapted for use with numerous breeds of dogs.

The invention has been described in such full, clear, concise, and exact terms so as to enable any person skilled in the art to which it pertains to make and use the same. It should be understood that variations, modifications, equivalents and substitutions for components of the specifically described embodiments of the invention may be made by those skilled in the art without departing from the spirit and scope of the invention as set forth in the appended claims. Persons who possess such skill will also recognize that the foregoing description is merely illustrative and not intended to limit any of the ensuing claims to any particular narrow interpretation.

I claim:

1. A device for training and/or playing with an animal, said device comprising:
(a) a strap member having a first end portion, a second end portion, and middle portion positioned between said first end portion and said second end portion;
(b) a throwing member secured to said first end portion of said strap member;
(c) a handle one of attached to and formed from said second end portion of said strap member; and
(d) a holding means having a predetermined size and shape, said holding means being secured to said middle portion of said strap member and providing a tool for one of training and playing with such animal.

2. The device as recited in claim 1 wherein said throwing member secured to said first end portion of said strap member is a ball.

3. The device as recited in claim 2 wherein said ball includes a hollow center and at least two openings through a wall portion thereof such that said first end portion of said strap member is threaded through said at least two openings to secure said ball to said strap member.

4. The device as recited in claim 1 wherein said strap member is formed from one of a reinforced nylon and canvas material.

5. The device as recited in claim 1 wherein said strap member is a single continuous loop and said handle is formed from said second end portion of said strap member.

6. The device as recited in claim 1 wherein said handle comprises one of a wood, rubber, and plastic member having an opening extending therethrough such that said handle is capable of being threaded onto said second end portion of said strap member.

7. The device as recited in claim 1 wherein said holding means comprises a pouch having at least one pocket therein for holding at least one item for one of training and playing with such animal.

8. The device as recited in claim 7 wherein said pouch further includes at least one opening for placing and removing said at least one item from within said pocket of said pouch.

9. The device as recited in claim 7 wherein said at least one opening includes means for closing said at least one opening.

10. The device as recited in claim 9 wherein said closing means comprises one of a hook and loop fastener, a zipper, at least one snap, and at least one button.

11. The device as recited in claim 7 wherein said at least one item comprises at least one treat, at least one squeaking device, and at least one feather.

12. The device as recited in claim 1 wherein said holding means is formed from a soft material.

13. The device as recited in claim 12 wherein said soft material comprises one of animal fur, imitation animal fur, heavy-duty fleece, and heavy-duty soft material.

14. The device as recited in claim 7 wherein said pouch includes a two or more pockets for holding a two or more different items.

15. The device as recited in claim 7 wherein said middle portion of said strap member is sewn throughout one of the interior and exterior portion of said pouch so as to reinforce said pouch.

16. The device as recited in claim 8 wherein said pouch includes at least one tab to assist in opening said at least one opening.
